(19) United States
(12) Patent Application Publication
(10) Pub. No.: US 2003/0080174 A1
(43) Pub. Date: May 1, 2003

(54) Header for surface mount between parallel circuit boards

(76) Inventor: Craig M. Kennedy, San Marcos, CA (US)

Correspondence Address: Jack Oisher, 200 High Point Road, Hartsdale, NY, 10530, US

(21) Appl. No.: 10/045,990

(22) Filed: Oct. 31, 2001

(51) Int. Cl. B23K 37/00

(52) U.S. Cl. 228/5.7

(57) ABSTRACT

A header includes a substrate made of an insulative material that has a plurality of through holes formed therein extending between upper and lower sides of the substrate. Plating is applied to the through holes to form conductive cylinders with upper and lower ends. A plurality of solder balls are attached to corresponding upper and lower ends of the conductive cylinders. A pair of circuit boards can be mechanically and electrically interconnected with the solder ball header in spaced apart parallel relationship. The solder balls bond the ends of the conductive cylinders with opposing conductive traces or pads formed on the circuit boards.

### BACKGROUND OF THE INVENTION

The present invention relates to interconnect devices used in electronic assemblies, and more particularly, to devices that require a surface mount to surface mount attachment of a conductive circuit on a first printed circuit board to a conductive circuit on a second parallel printed circuit board.

In the electronics industry there is frequently a need to connect circuitry formed on a first printed circuit board with circuitry formed on a second printed circuit board which is closely adjacent to, and parallel, to the first circuit board. In the past, ribbon cables, edge card connecters and other flexible wire interconnect assemblies have been developed for this purpose. However, they are relatively expensive, particularly where disconnectable couplings are not required. This is often the case where a so-called “mother board” in a personal computer is connected to a dedicated graphics processing board, for example.

Various approaches have also been developed for interconnecting adjacent parallel circuit boards utilizing conductive pins. These conductive pins are typically rigid and are attached by re-flowed solder paste commonly known in the industry as “pin and paste” or butt-solder joint” attachment. However, utilizing this type of interconnect to mechanically and electrically connect parallel circuit boards has been problematic. Pin and paste or butt-solder joint attachments use minimal solder paste which results in inferior joints. The circuit boards are not co-planar and this varies the amount of solder between the pins and the opposing conductive pads, resulting in excessive elongation of joints and leaving thin sections of solder attachment which are weak. Differences in thermal expansion between the two circuit boards can cause the inferior solder joints to exhibit fractures that can result in high resistance or open circuits.

Besides providing electrical interconnections between adjacent circuit boards, it is desirable to apply the same interconnection scheme to provide the mechanical support between the printed circuit boards, thereby reducing the overall parts costs. It would therefore be desirable to provide an improved low-cost reliable device for providing electrical and mechanical connections between adjacent printed circuit boards. It would further be desirable that this device be readily adapted for interconnecting printed circuit boards that are designed for so-called “surface mount technology” (SMT) mounting of electronic components thereon. Current SMT techniques utilize so called “dog bone” conductive traces or pads that provide large rounded areas for the solder balls that are remote from the vertical connectors. This offset approach is wasteful in terms of requiring excess amounts of circuit board real estate.

### SUMMARY OF THE INVENTION

In accordance with the present invention a header comprises a substrate made of an insulative material and having a plurality of through holes formed therein extending between upper and lower sides of the substrate. Plating is applied to the through holes to form conductive cylinders with upper and lower ends. A plurality of solder balls or other pre-formed heat re-flowable bonding members are attached directly to corresponding upper and lower ends of the conductive cylinders.

### BRIEF DESCRIPTION OF THE DRAWINGS

FIG. 1 is a top plan view of a solder ball header forming a preferred embodiment of the present invention.

FIG. 2 is a side elevation view of the solder ball header of FIG. 1 taken from the top of FIG. 1.

FIG. 3 is an enlarged vertical section view of the solder ball header taken along line 3-3 of FIG. 2. This figure is not drawn to scale.

FIG. 4 is a vertical sectional view of the solder ball header of FIGS. 1-3 interconnecting upper and lower printed circuit boards. This figure is not drawn to scale.

FIG. 5 is a top plan view of an alternate embodiment of the solder ball header of the present invention.

FIG. 6 is a side elevation view of the alternate embodiment of FIG. 5.

FIG. 7 is a top plan view of another embodiment of the header of the present invention.

FIG. 8 is a sectional view taken along line 8-8 of FIG. 7 illustrating the mounting of the header of FIG. 7 on a circuit board via locator pins. This figure is not drawn to scale.

FIG. 9 is a top plan view of another alternate embodiment including an outrigger support.

FIG. 10 is a sectional view of the alternate embodiment of FIG. 9 taken along line 10-10 of FIG. 9.

FIG. 11 is a top plan view of another alternate embodiment including an H-shaped substrate.

FIG. 12 is an end elevation view of the alternate embodiment of FIG. 11 taken from the right hand side of FIG. 11.

FIG. 13 is a top plan view of another alternate embodiment including a stright substrate segment with guide pins.

FIG. 14 is an end elevation view of the alternate embodiment of FIG. 13 taken from the right hand side of FIG. 13.

FIG. 15 is a top plan view of another alternate embodiment including a straight substrate segment and flat solder pads.

FIG. 16 is an end elevation view of the alternate embodiment of FIG. 15 taken from the right hand side of FIG. 15.

### DESCRIPTION OF THE PREFERRED EMBODIMENTS

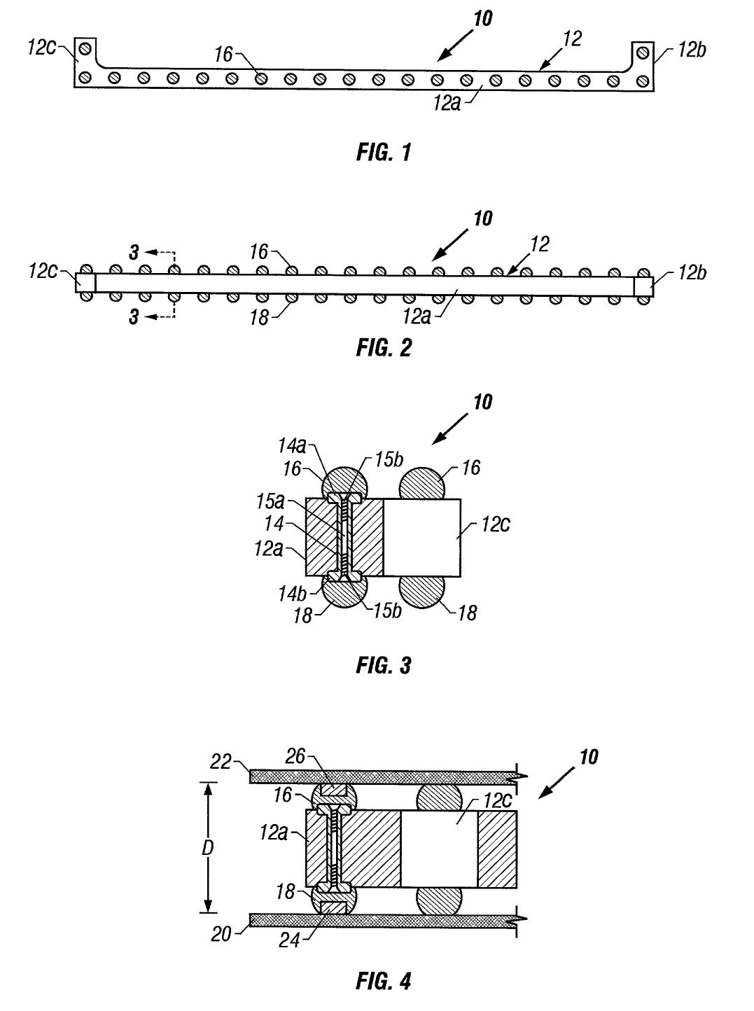

Referring to FIGS. 1 and 2, a generally C-shaped header 10 includes a substrate 12 made of a suitable dielectric (insulating) material such as FR-4 glass filled epoxy. A plurality of holes are drilled through or otherwise formed in the substrate 12 and are plated to provide conductive cylinders such as 14. Each conductive cylinder 14 is formed with an axially extending hole 15a in the center thereof which is flared at either end. The axially extending hole 15a (FIG. 3) is plated solid, filled with solder or epoxy, or filled by inserting a pin. A generic plug 15b is illustrated in FIG. 3 filling the hole 15a. The plug 15b may be formed by any of the foregoing techniques.

The holes formed through the substrate 12 could be countersunk at either end in order to ensure that cylindrical or disc-shaped end portions 14a and 14b are formed on either end of the conductive cylinder 14. Generally round solder balls 16 are automatically deposited onto the end portions 14a of each of the conductive cylinders 14 and are heated a sufficient amount so they will bond to the upper ends of their corresponding conductive cylinders 14. The header 10 is then inverted, and solder balls 18 are deposited on the end portions 14b of the conductive cylinders 14, and heated a sufficient amount to bond thereto. Solder balls 16 and 18 may be made of, for example, a 63-37 weight percent alloy of tin and lead.

The solder ball header 10 may be utilized to provide a permanent mechanical and electrical connection between upper and lower planar printed circuit boards 20 and 22 (FIG. 4). The circuit boards 20 and 22 of this assembly are formed of any suitable dielectric (insulating) substrate material,

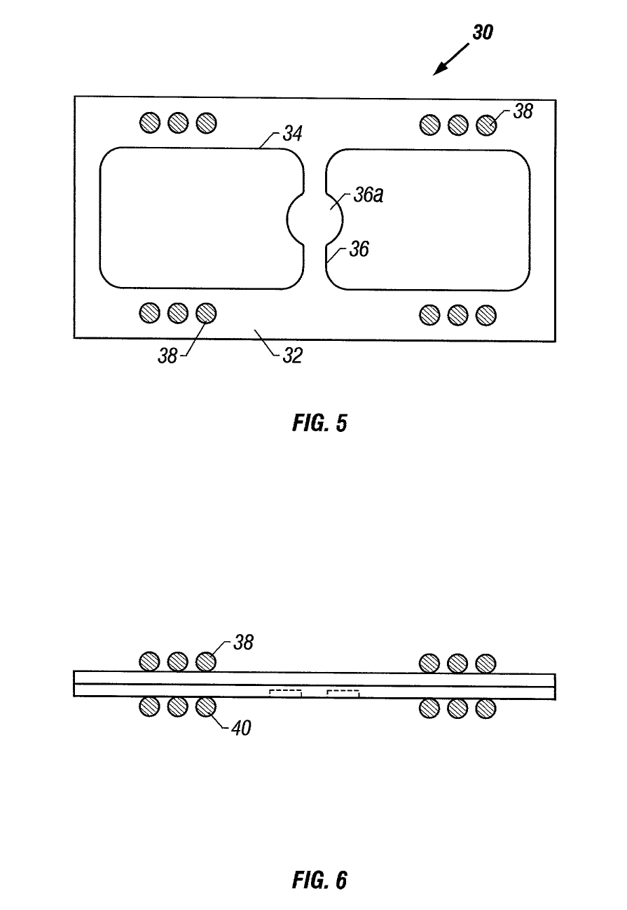

FIG. 5 illustrates an alternate embodiment 30 of the present invention configured for handling by the pneumatic head of an automatic pick and place machine. It includes a rectangular frame 32 made of suitable dielectric (insulative) material defining a large rectangular opening 34 spanned by a central cross-beam 36. Cross-beam 36 has a central circular region 36a which is sucked up to the pneumatic head of the automatic pick and place machine. The frame 32 has plated-through holes (not visible) providing conductive cylinders similar to conductive cylinders 14 of the solder ball header 10. As best seen in FIG. 6, solder balls 38 and 40 are bonded to the upper and lower ends of these tubular conductors. The solder balls 38 and 40 serve the same function as the solder balls 16 and 18 of the solder ball header 10 when the second embodiment 30 is used to interconnect lower printed circuit boards.

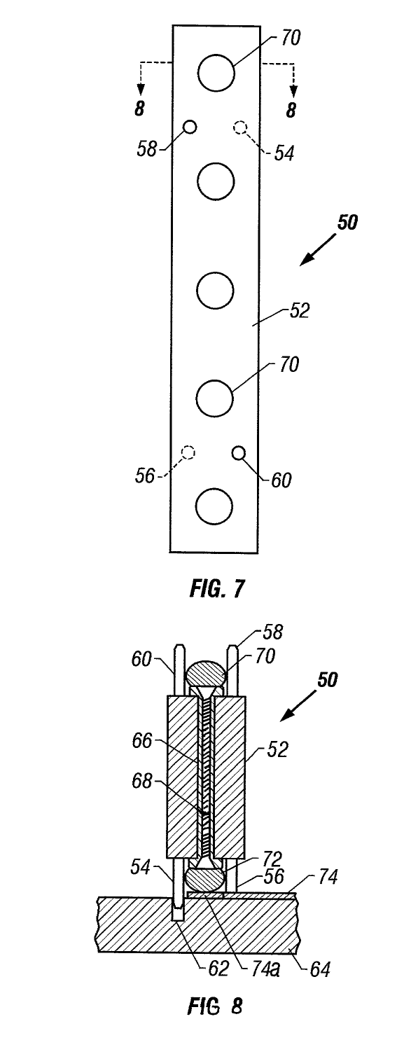

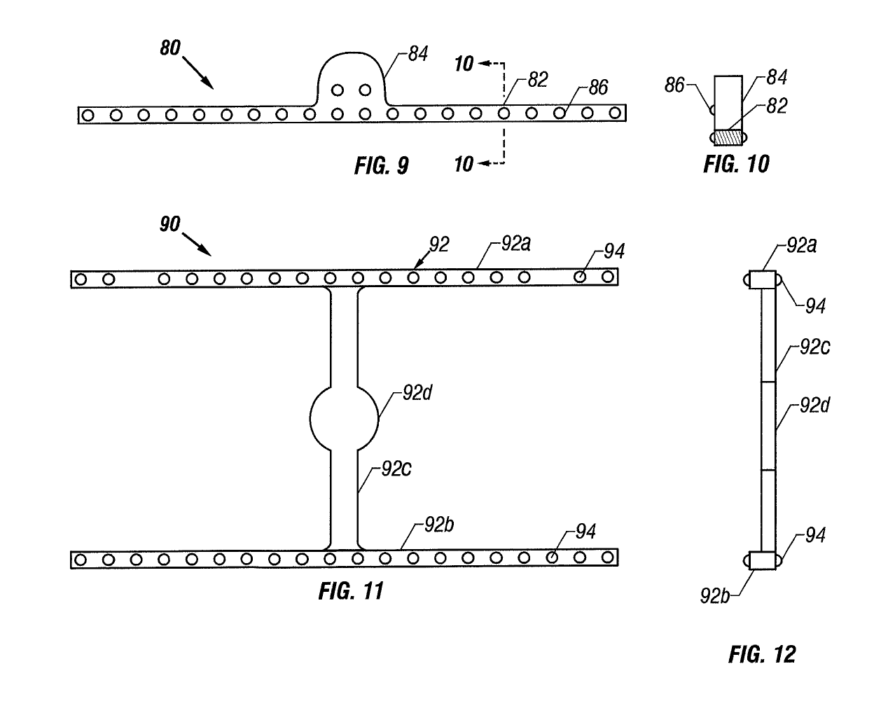

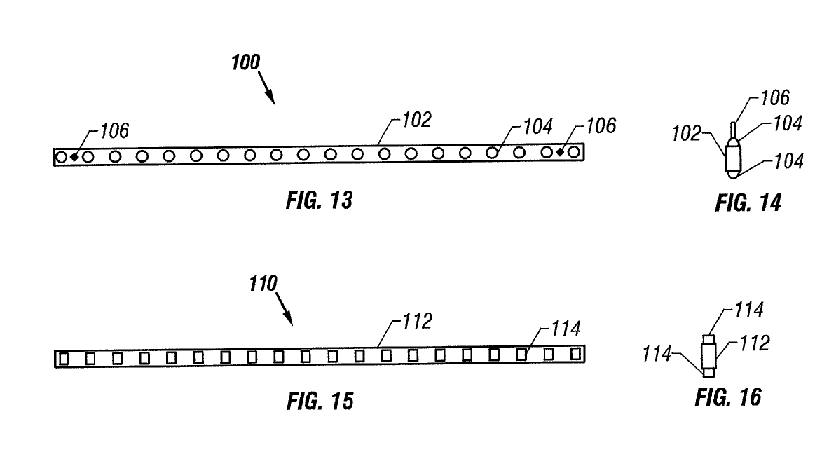

Referring to FIGS. 7 and 8, yet another embodiment 50 of the header of the present invention includes a longitudinally extending rectangular substrate 52. Longitudinally spaced, laterally offset locator pins 54 and 56 extend from the lower side of the substrate 52. Longitudinally spaced, laterally offset locator pins 58 and 60 extend from the upper side of the substrate 52. The locator pins 54 and 56 are received in locator holes such as 62 formed in a lower circuit board 64. The locator pins 58 and 60 are received in locator holes in an upper circuit board, not illustrated. The substrate 52 has conductive cylinders 66 (FIG. 8) which have plugs 68. Solder balls such as 70 and 72 are attached to the upper and lower ends of each of the conductive cylinders 66 which form rings.

The locator pins 54, 56, 58 and 60 ensure precise registration of the header 50 with the upper and lower circuit boards and prevent the header 52 from tipping over during solder re-flow. The locator pins also eliminate any need for the substrate to have a laterally extending leg like the C-shaped header 10 of FIG. 1. The solder ball 72 illustrated in FIG. 8 bonds the lower end or ring of the conductive cylinder 66 to a conductive trace 74 formed on the upper side of the lower circuit board 64. The trace 74 terminates in a circular pad 74a to which solder ball 72 is bonded.

In the embodiments described above, solder balls have been utilized to form the electrical and mechanical interconnections between the upper and lower circuit boards. However, it will be segment 102 at each end thereof on one side of the segment 102 for registration with mounting holes in a printed circuit board.

Referring to FIGS. 15 and 16, another embodiment 110 includes a single straight substrate segment 112 with plated through-holes (not visible) having rectangular solder flat pads 114 attached to the opposite ends of the plated through-holes.

While the present invention has been described in terms of several embodiments, it should be apparent to those skilled in the art that the subject invention can be modified in both arrangement and detail. The pre-formed heat re-flowable bonding members could be arranged in any pattern on the substrate, including irregular patterns. Also, the references to upper and lower are merely for the sake of clarity in describing the relationship of the structures, which can be placed in any orientation. Therefore, the protection afforded the invention should only be limited in accordance with the scope of the following claims.

What is claimed is:

1. A header, comprising
a substrate made of an insulative material and having a plurality of through holes formed therein extending between upper and lower sides of the substrate;
plating applied to the through holes to form conductive cylinders with upper and lower ends; and
a plurality of pre-formed heat re-flowable bonding members attached to corresponding upper and lower ends of the conductive cylinders.

2. The header of claim 1 wherein the pre-formed heat re-flowable bonding members are solder balls.

3. The header of claim 1 wherein the pre-formed heat re-flowable bonding members are shaped solder deposits.

4. The header of claim 1 wherein the substrate has a C-shape including main portion extending in a longitudinal direction and a pair of legs extending in a lateral direction.

5. The header of claim 4 wherein conductive cylinders extend through both the main portion and the legs of the substrate.

6. The header of claim 1 wherein the solder balls are made of a 63-37 weight percent alloy of tin and lead.

7. The solder ball header of claim 1 wherein the substrate is formed of an FR-4 glass filled epoxy.

8. The header of claim 1 wherein the conductive cylinders are formed with a central axially extending hole.

9. The header of claim 9 and further comprising a plurality of plugs each filling the central axially extending hole of a corresponding conductive cylinder.

10. The header of claim 1 and further comprising at least one locator pin having a first end secured in the substrate and a second end extending from the substrate for registration with a locator hole in a circuit board.

11. A circuit board assembly, comprising:
an upper circuit board including a plurality of conductive elements formed on a surface thereof;
a lower circuit board including a plurality of conductive elements formed on a surface thereof;
a header including a substrate made of an insulative material and having a plurality of through holes formed therein extending between an upper side of the substrate and a lower side of the substrate, and plating applied to the through holes to form conductive cylinders with upper and lower ends; and
a plurality of pre-formed heat re-flowable bonding members attached to corresponding upper and lower ends of the conductive cylinders and corresponding conductive elements of the upper and lower circuit boards to mechanically and electrically connect the upper lower circuit boards in spaced apart, substantially parallel relationship.

12. The assembly of claim 11 wherein the header has a generally C-shaped configuration.

13. The assembly of claim 11 wherein the conductive cylinders each have a hole formed there through.

14. The assembly of claim 11 wherein the conductive cylinders are solid throughout their length.

15. The assembly of claim 11 wherein each pre-formed heat re-flowable bonding member comprises a solder ball.

16. The assembly of claim 16 wherein each solder ball wraps around a side wall of a corresponding conductive element and a side wall of an end of a corresponding conductive cylinder.

17. The assembly of claim 11 wherein the conductive cylinders have holes therethrough which are plugged by a pin.

18. The assembly of claim 11 wherein the conductive cylinders have holes therethrough which are plugged with a conductive epoxy.

19. The assembly of claim 1 1 wherein the conductive cylinders each have upper and lower disc-shaped end portions.

20. A circuit board assembly, comprising;
upper and lower generally planar circuit boards each formed with an array of conductive elements, the circuit boards being mechanically and electrically interconnected in a substantially spaced apart, parallel relationship by at least one solder ball header, the solder ball header including an elongate substrate made of an insulative material having a plurality of spaced apart through holes, each of the through holes having a conductive cylinder extending therethrough, each of the conductive cylinders having upper and lower disc-shaped end portions, and a plurality of solder balls each bonded to a corresponding opposing conductive cylinder end portion and conductive element, the solder balls wrapping around vertical side walls of the conductive cylinder end portions and conductive elements.
